(19) United States
(12) Patent Application Publication
(10) Pub. No.: US 2025/0076911 A1
(43) Pub. Date: Mar. 6, 2025

(54) VOLTAGE REGULATOR CIRCUIT WITH REDUCED LEAKAGE IN OFF-STATE

(71) Applicant: Apple Inc., Cupertino, CA (US)

(72) Inventors: Gaurav SHARMA, Sunnyvale, CA (US); Nathan F. HANAGAMI, San Francisco, CA (US)

(21) Appl. No.: 18/457,293

(22) Filed: Aug. 28, 2023

(51) Int. Cl. G05F 1/575

(52) U.S. Cl. CPC G05F 1/575

(57) ABSTRACT

A power circuit for a computer system is disclosed. The power circuit includes a voltage regulator circuit and a pull-down circuit. While activated, the voltage regulator circuit generates a particular voltage level on a regulated power supply node. In response to the voltage regulator circuit being deactivated, the pull-down circuit couples a first resistor between the regulated power supply node and a ground supply node. After a period of time has elapsed since the deactivation of the voltage regulator circuit, the pull-down circuit decouples the first resistor, and couples a second resistor, whose value is greater than the first resistor, between the regulated power supply node and the ground supply node.

### FIELD

The described embodiments relate generally to integrated circuits and, more particularly, to reducing leakage currents in voltage regulator circuits.

### BACKGROUND

Modern computer systems may include multiple circuit blocks designed to perform various functions. For example, such circuit blocks may include processors or processor cores configured to execute software or program instructions. Additionally, the circuit blocks may include memory circuits, mixed-signal circuits, analog circuits, and the like.

In some computer systems, the circuit blocks may be designed to operate at different power supply voltage levels. Power management circuits may be included in such computer systems to generate and monitor varying power supply voltage levels for the different circuit blocks.

Power circuits often include one or more voltage regulator circuits configured to regulate voltage levels on respective power supply nodes using a voltage level of an input power supply node and a reference voltage. Such regulator circuits may employ multiple passive circuit elements, such as inductors, capacitors, and the like.

### BRIEF DESCRIPTION OF THE DRAWINGS

FIG. 1 is a block diagram of an embodiment of a power circuit.

FIG. 2 is a block diagram of an embodiment of a pull-down circuit.

FIG. 3 is a block diagram depicting a embodiment of a control circuit for a pull-down circuit.

FIG. 4 is a block diagram depicting an embodiment of a voltage regulator circuit.

FIG. 5A is a block diagram of an embodiment of a variable resistance circuit.

FIG. 5B is a block diagram of another embodiment of a variable resistance circuit.

FIG. 6A illustrates examples waveforms associated with the operation of a power circuit.

FIG. 6B illustrates other example waveforms associated with the operation of a power circuit.

FIG. 7 is a flow diagram depicting an embodiment of a method for operating a power circuit.

FIG. 8 is a block diagram of an embodiment of a system-on-a-chip.

FIG. 9 is a block diagram of various embodiments of computer systems that may include power management circuits.

FIG. 10 illustrates an example of a non-transitory computer-readable storage medium that stores circuit design information.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Computer systems may include multiple circuit blocks configured to perform specific functions. Such circuit blocks may be fabricated on a common substrate and may employ different power supply voltage levels. To provide the various power supply voltage levels employed by the multiple circuit blocks, computer systems can include multiple power circuits configured to generate regulated power supply voltage levels.

Various types of power circuits, e.g., buck converters, may be employed depending on load current demand, desired value of the regulated voltage, desired efficiency of the voltage regulation process, and the like. One type of power circuit employed is a low-dropout (LDO) regulator circuit. LDO regulator circuits can be employed when the desired value of the regulated voltage is close to a voltage level of an input power supply node. Moreover, since LDO regulator circuits are not switching regulator circuits, LDO regulator circuits can be employed when low power supply noise is desired.

An LDO regulator circuit can be implemented with a transistor or other suitable transconductance device coupled between an input power supply node and a regulated power supply node. The conductance of the transistor is adjusted based on a voltage level of the regulated power supply node as compared to a reference voltage to achieve a desired voltage on the regulated power supply node. During some power gating operations, the transistor is placed in an off state so that little current can flow into the regulated power supply node allowing the voltage level of the regulated power supply node to slowly decrease over time.

During a power gating operation, a resistor may be coupled between a regulated power supply node and a ground supply node to discharge the regulated power supply node. When an LDO regulator circuit is employed, the drop in the voltage of the regulated power supply node can result in a sufficient drain-to-source voltage across the transistor in the LDO regulator circuit resulting in a substantial leakage current. Such a leakage current can result in power dissipation by the LDO regulator circuit even when the LDO regulator circuit is disabled, thereby limiting the effectiveness of the power gating operation.

The embodiments illustrated in the drawings and described below provide techniques for reducing leakage current for LDO voltage regulator circuits. By employing different pull-down resistance values at different times, a regulated power supply node may be rapidly discharged upon deactivation of an LDO voltage regulator circuit, and then placed on a low-leakage configuration (or “mode”) after a particular time period has elapsed, thereby reducing power consumption when the LDO regulator circuit is deactivated.

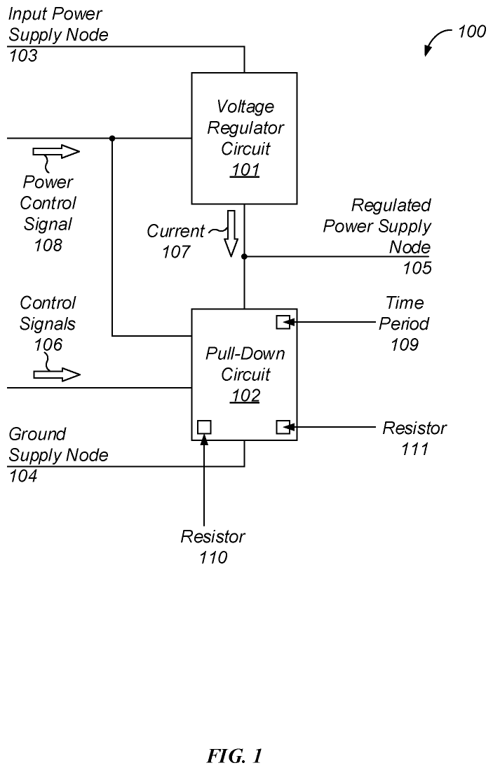

A block diagram of a power circuit is depicted in FIG. 1. As illustrated, power circuit 100 includes voltage regulator circuit 101 and pull-down circuit 102.

Voltage regulator circuit 101 is configured to generate a particular voltage level on regulated power supply node 105 in response to an activation of power control signal 108. To generate the particular voltage level on regulated power supply node 105, voltage regulator circuit 101 is further configured to source current 107 to regulated power supply node 105 using a voltage level of input power supply node 103. In various embodiments, voltage regulator circuit 101 is configured, in response to a deactivation of power control signal 108, to enter an inactive state and halt sourcing current to regulated power supply node 105. As described below, voltage regulator circuit 101 may, in some embodiments, be implemented as an LDO voltage regulator circuit.

Pull-down circuit 102 is configured, in response to a deactivation of voltage regulator circuit 101, to couple resistor 110 between regulated power supply node 105 and ground supply node 104. In response to a determination that time period 109 has elapsed, pull-down circuit 102 is further configured to couple resistor 111 between regulated power supply node 105 and ground supply node 104. In various embodiments, a value of resistor 111 is greater than a value of resistor 110. In some embodiments, pull-down circuit 102 is further configured to decouple resistor 110 from regulated power supply node 105 prior to coupling resistor 111 to regulated power supply node 105. As described below, pull-down circuit 102 may be further configured to adjust a value of resistor 111 based on control signals 106.

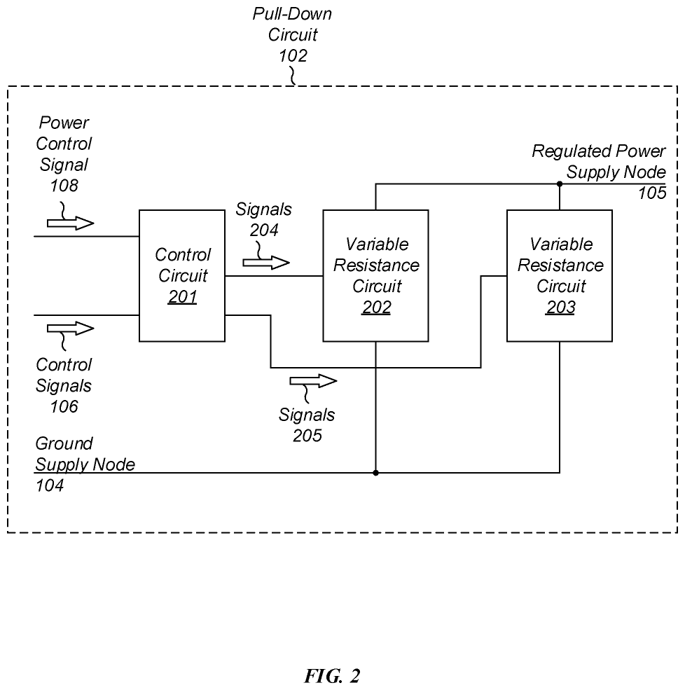

Turning to FIG. 2, a block diagram of an embodiment of pull-down circuit 102 is depicted. As illustrated, pull-down circuit 102 includes control circuit 201, variable resistance circuit 202, and variable resistance circuit 203.

Control circuit 201 is configured to generate signals 204 and signals 205 using power control signal 108 and control signals 106. In various embodiments, control circuit 201 is configured to activate particular ones of signals 204 in response to an activation of power control signal 108. Control circuit 201 may be further configured to activate particular ones of signals 205 in response to a determination that a particular time period has elapsed since deactivation of power control signal 108. In some embodiments, control circuit 201 may be further configured to determine which of signals 205 is activated based on which of control signals 106 is active. Control circuit 201 is also configured to deactivate signals 204 and signals 205 in response to a determination that power control signals 108 has been activated.

Control circuit 201 may be implemented using any suitable combination of combinatorial and sequential logic circuits. As described below, control circuit 201 may include a counter circuit or timer circuit configured to track the particular time period. Control circuit 201 may also include a decoder circuit configured to generate signals 205 based on control signals 106.

Variable resistance circuit 202 is configured, in response to an activation of at least one of signals 204, to couple a resistor between regulated power supply node 105 and ground supply node 104. In various embodiments, a subset of signals 204 may control a value of the resistor coupled between regulated power supply node 105 and ground supply node 104. In some embodiments, the value of the resistor coupled between regulated power supply node 105 and ground supply node 104 may be based on a desired discharge time for regulated power supply node 105 when voltage regulator circuit 101 is deactivated. Variable resistance circuit 202 is further configured to decouple the resistor from regulated power supply node 105 in response to a deactivation of signals 204.

Variable resistance circuit 203 is configured, in response to an activation of at least one of signals 205, to couple a resistor between regulated power supply node 105 and ground supply node 104. In various embodiments, a subset of signals 205 may control a value of the resistor coupled between regulated power supply node 105 and ground supply node 104. In some embodiments, the value of the resistor coupled between regulated power supply node 105 and ground supply node 104 may be based on a desired amount of leakage current through voltage regulator circuit 101 when voltage regulator circuit 101 is deactivated. In some embodiments, the value of the resistor coupled between regulated power supply node 105 and ground supply node 104 may be adjusted based on a temperature of the computer system that includes power circuit 100. Variable resistance circuit 203 is also configured to decouple the resistor from regulated power supply node 105 in response to a deactivation of signals 205.

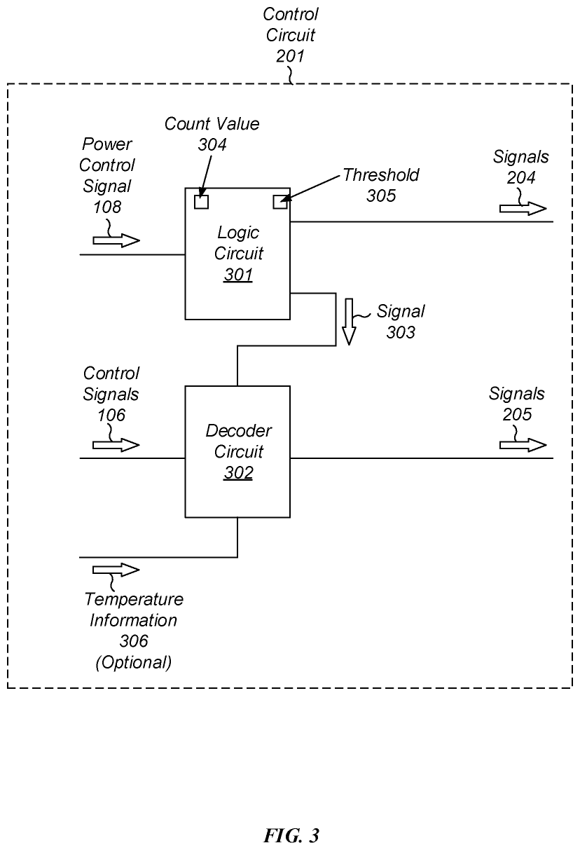

A block diagram of an embodiment of control circuit 201 is depicted in FIG. 3. As illustrated, control circuit 201 includes logic circuit 301 and decoder circuit 302. It is noted that although signals 204 and signals 205 are depicted as being single wires, in other embodiments, signals 204 and signals 205 may include any suitable number of wires.

Logic circuit 301 is configured to generate signals 204 and signal 303 using power control signal 108. In various embodiments, logic circuit 301 may be configured to activate various ones of signals 204 in response to a deactivation of power control signal 108. Additionally, logic circuit 301 may be further configured to begin periodically incrementing count value 304 in response to the activation of power control signal 108. Logic circuit 301 may be configured to activate signal 303 in response to a determination that count value 304 exceeds threshold 305. In various embodiments, threshold 305 may be set based on a desired discharge time for regulated power supply node 105 once voltage regulator circuit 101 has been deactivated. Logic circuit 301 may also be configured to deactivate signals 204 and signal 303 in response to an activation of power control signal 108.

Decoder circuit 302 is configured to generate signals 205 using control signals 106, signal 303, and, optionally, temperature information 306. In various embodiments, decoder circuit 302 may be configured to activate various ones of signals 205 in response to an activation of signal 303 and based on a decode of control signals 106. In some embodiments, decoder circuit 302 may further employ temperature information 306 to activate the various ones of signals 205. It is noted that, in some embodiments, corresponding values of control signals 106 may be based on a temperature of power circuit 101.

In various embodiments, logic circuit 301 and decoder circuit 302 may be implemented using any suitable combination of combinatorial and sequential logic circuits. In some embodiments, logic circuit 301 may include a counter circuit configured to increment count value 304 at regular intervals.

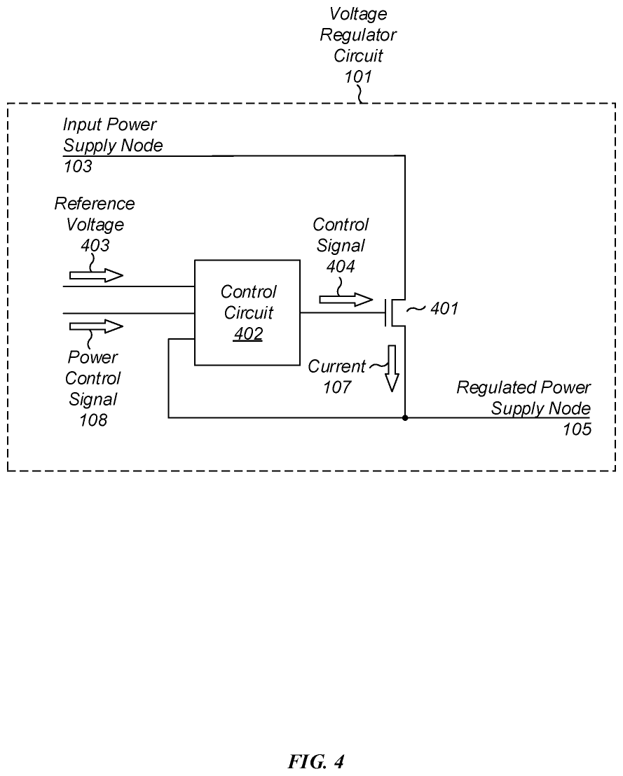

Turning to FIG. 4, a block diagram of an embodiment of voltage regulator circuit 101 is depicted. As illustrated, voltage regulator circuit 101 includes transistor 401 and control circuit 402.

Transistor 401 is coupled between input power supply node 103 and regulated power supply node 105. In various embodiments, transistor 401 is configured to adjust a conductance between input power supply node 103 and regulated power supply node 105 based on control signal 404, thereby generating current 107.

In various embodiments, transistor 401 may be implemented as an n-channel metal-oxide semiconductor field-effect transistor (MOSFET), a Fin field-effect transistor (FinFET), a gate-all-around field-effect transistor (GAAFET), or any other suitable transconductance device. Although transistor 401 is depicted as a single transistor, in other embodiments, transistor 401 may be implemented using any suitable number of transistors coupled together in parallel, in series, or any suitable combination thereof.

Control circuit 402 is configured to generate control signal 404 using reference voltage 403, power control signal 108, and a voltage level of regulated power supply node 105. In response to a determination that power control signal 108 has been activated, control circuit 402 may be configured to perform a comparison of reference voltage 403 and the voltage level of regulated power supply node 105. In various embodiments, control circuit 402 may be further configured to generate control signal 404 using a result of the comparison. In some embodiments, control circuit 402 may be configured to generate control signal 404 such that a voltage level of control signal 404 is proportional to a difference between reference voltage 403 and the voltage level of regulated power supply node 105.

Control circuit 402 may be further configured, in response to a determination that power control signal 108 has been deactivated, to set control signal 404 to a voltage level that deactivates transistor 401, thereby placing voltage regulator circuit 101 in an inactive (or deactivated) state. For example, in some embodiments, control circuit 402 may set control signal 404 to a voltage level at or near ground potential in response to the determination that power control signal 108 has been deactivated.

In various embodiments, control circuit 402 may be implemented using a comparator circuit or other suitable differential amplifier circuit. Control circuit 402 may also be implemented using any suitable combination of combinatorial and sequential logic circuits.

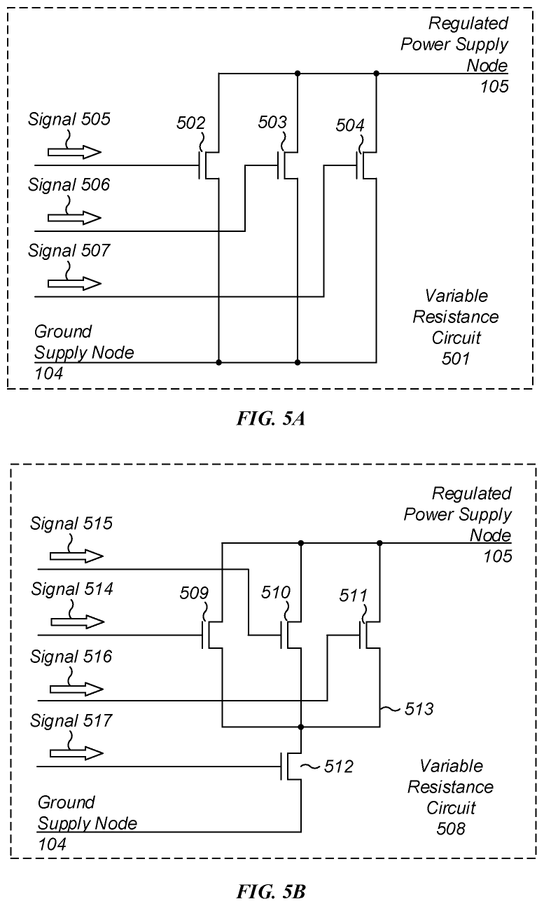

Turning to FIG. 5A, a block diagram of an embodiment of a variable resistance circuit is depicted. As illustrated, variable resistance circuit 501 includes transistors 502-504. It is noted that variable resistance circuit 501 may correspond to either of variable resistance circuit 202 or variable resistance circuit 203.

Transistors 502-504 are coupled between regulated power supply node 105 and ground supply node 104. Transistor 502 is configured to couple regulated power supply node 105 to ground supply node 104 in response to an activation of signal 505. In a similar fashion, transistors 503 and 504 are configured to couple regulated power supply node 105 to ground supply node 104 in response to an activation of signals 506 and 507, respectively. In various embodiments, signals 505-507 may correspond to either of signals 204 or signals 205.

In various embodiments, to adjust a resistance between regulated power supply node 105 and ground supply node 104, different ones of transistors 502-504 may be activated. For a larger resistance between regulated power supply node 105 and ground supply node 104, a single one of transistors 502-504 may be activated while, for a smaller resistance between regulated power supply node 105 and ground supply node 104, all of transistors 502-504 may be activated. Although only three transistors and their associated control signals are depicted in the embodiment of FIG. 5A, in other embodiments, any suitable number of transistors may be employed.

Transistors 502-504 may be implemented as n-channel MOSFETs, FinFETs, GAAFETs, or any other suitable transconductance devices. In some cases, transistors 502-504 may have different beta ratios resulting from different physical characteristics (e.g., transistor width and transistor length) to achieve a desired range of possible resistance values between regulated power supply node 105 and ground supply node 104. In other embodiments, resistors, or other passive series resistances, may be coupled in series with the sources and/or drains of transistors 502-504. Although transistors 502-504 are depicted as single transistors in the embodiment of FIG. 5A, in other embodiments, any of transistors 502-504 may be implemented using any suitable series and/or parallel combination of transistors.

Turning to FIG. 5B, a block diagram of another embodiment of a variable resistance circuit is depicted. As illustrated, variable resistance circuit 508 includes transistors 509-512. It is noted that variable resistance circuit 508 may correspond to either of variable resistance circuit 202 or variable resistance circuit 203.

Transistors 509-511 are coupled between regulated power supply node 105 and node 513, while transistor 512 is coupled between node 513 and ground supply node 104. Transistor 509 is configured to couple regulated power supply node 105 to node 513 in response to an activation of signal 514. In a similar fashion, transistors 510 and 511 are configured to couple regulated power supply node 105 to node 513 in response to an activation of signals 515 and 516, respectively. Transistor 512 is configured to couple node 513 to ground supply node 104 in response to an activation of signal 517. In various embodiments, signals 514-517 may correspond to either of signals 204 or signals 205.

In various embodiments, to adjust a resistance between regulated power supply node 105 and ground supply node 104, transistor 512 and different ones of transistors 509-511 may be activated. For a larger resistance between regulated power supply node 105 and ground supply node 104, a single one of transistors 509-511 along with transistor 512 may be activated while, for a smaller resistance between regulated power supply node 105 and ground supply node 104, all of transistors 509-511 along with transistor 512 may be activated. Although only three transistors and their associated control signals are depicted as being coupled between regulated power supply node and node 513, in other embodiments, any suitable number of transistors may be employed. It is noted that the use of transistor 512 may, in some embodiments, reduce leakage current through variable resistance circuit 508 during periods when voltage regulator circuit 101 is inactive by reducing drain-to-source voltages across transistors 509-511.

Transistors 509-512 may be implemented as n-channel MOSFETs, FinFETs, GAAFETs, or any other suitable transconductance devices. In some cases, transistors 509-512 may have different beta ratios resulting from different physical characteristics (e.g., transistor width and transistor length) to achieve a desired range of possible resistance values between regulated power supply node 105 and ground supply node 104. In other embodiments, resistors, or other passive series resistances, may be coupled in series with the sources and/or drains of transistors 509-512. Although transistors 509-512 are depicted as single transistors in the embodiment of FIG. 5B, in other embodiments, any of transistors 509-512 may be implemented using any suitable series and/or parallel combination of transistors.

It is noted that the embodiments depicted in FIGS. 5A and 5B are just two examples of variable resistance circuits. In other embodiments, different variable resistance using different types of circuit elements may be employed. For example, in some embodiments, a variable resistance circuit may be implemented with multiple resistors and switches, while, in other embodiments, a variable resistance circuit may be implemented using biased transistors to provide a desired resistance.

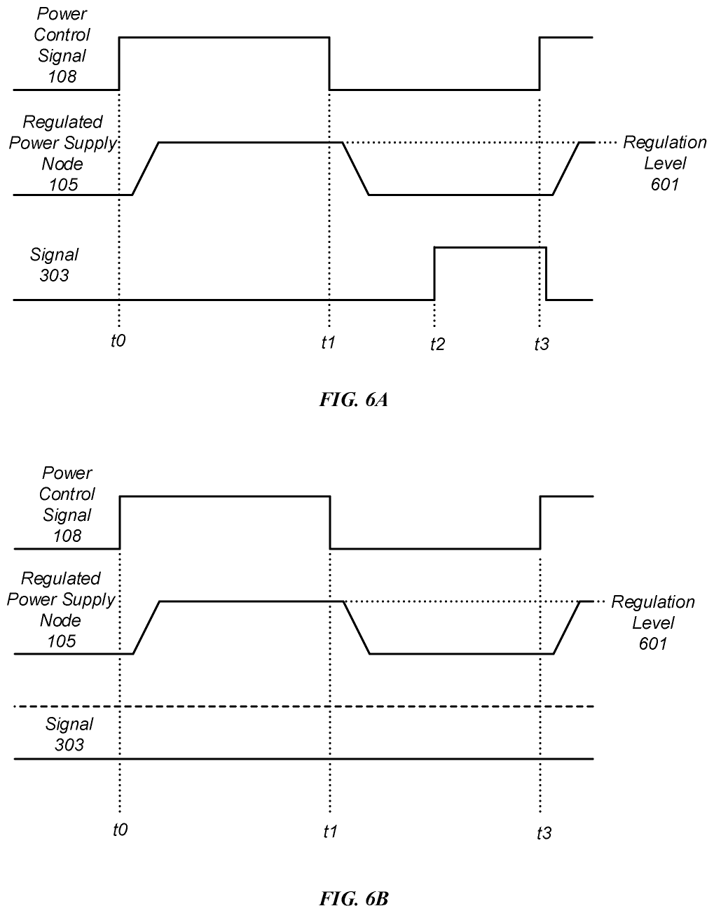

Turning to FIG. 6A, example waveforms associated with the operation of a power circuit using a low-leakage mode are depicted. At time t0, power control signal 108 is activated, enabling voltage regulator circuit 101. Once enabled, voltage regulator circuit 101 sources current 107 to regulated power supply node 105 causing the voltage level of regulated power supply node 105 to increase to regulation level 601.

At time t1, power control signal 108 is deactivated, which deactivates voltage regulator circuit 101. The deactivation of power control signal 108 also causes variable resistance circuit 202 to couple regulated power supply node 105 to ground supply node 104, resulting in a decrease in the voltage level of regulated power supply node 105.

At time t2, signal 303 is activated by logic circuit 301. As described above, the activation of signal 303 causes variable resistance circuit 202 to decouple from regulated power supply node 105, and causes variable resistance circuit 203 to be coupled between regulated power supply node 105 and ground supply node 104. As previously noted, the resistance of variable resistance circuit 203 is higher than that of variable resistance circuit 202, resulting in lower leakage current through voltage regulator circuit 101. As described above, the duration between when power control signal 108 is deactivated and signal 303 is activated may be programmable and may, in some embodiments, be based on how long it takes to discharge regulated power supply node 105.

At time t3, power control signal 108 is activated, enabling voltage regulator circuit 101 so that regulated power supply node 105 may return to regulation level 601. The activation of power control signal 108 may additionally result in the deactivation of signal 303, decoupling variable resistance circuit 203 from regulated power supply node 105.

It is noted that although only one complete cycle of power control signal 108 is depicted in the diagram of FIG. 6A, in other embodiments, any suitable number of cycles of power control signal 108 may be employed. It is also noted that the relative timing of the signals depicted in FIG. 6A is merely an example and that, in other embodiments, the relative timing between the signals may be different.

In some cases, it may be desirable to disable the low-leakage mode. Example waveforms associated with the operation of a power circuit with the low-leakage mode disabled are illustrated in FIG. 6B. At time t0, power control signal 108 is activated, enabling voltage regulator circuit 101. Once enabled, voltage regulator circuit 101 sources current 107 to regulated power supply node 105 causing the voltage level of regulated power supply node 105 to increase to regulation level 601.

At time t1, power control signal 108 is deactivated, which deactivates voltage regulator circuit 101. The deactivation of power control signal 108 also causes variable resistance circuit 202 to couple regulated power supply node 105 to ground supply node 104, resulting in a decrease in the voltage level of regulated power supply node 105. Since the low-leakage mode is disabled, signal 303 remains in an inactive state.

At time t3, power control signal 108 is activated, enabling voltage regulator circuit 101 so that regulated power supply node 105 may return to regulation level 601. The activation of power control signal 108 may additionally result in variable resistance circuit 202 being decoupled from regulated power supply node 105.

It is noted that although only one complete cycle of power control signal 108 is depicted in the diagram of FIG. 6B, in other embodiments, any suitable number of cycles of power control signal 108 may be employed. It is also noted that the relative timing of the signals depicted in FIG. 6B is merely an example and that, in other embodiments, the relative timing between the signals may be different.

To summarize, various embodiments of a power circuit are disclosed. Broadly speaking, a power circuit includes a voltage regulator circuit and a pull-down circuit. The voltage regulator circuit may be configured to generate a particular voltage level on a regulated power supply node. The pull-down circuit may be configured, in response to a deactivation of the voltage regulator circuit, to couple a first resistor between the regulated power supply node and a ground supply node for a particular time period. The pull-down circuit may be further configured, in response to a determination that the particular time period has elapsed, to couple a second resistor between the regulated power supply node and the ground supply node, where a first value of the first resistor is less than a second value of the second resistor. In some embodiments, pull-down circuit may be also configured to decouple the first resistor in response to the determination that the particular time period has elapsed.

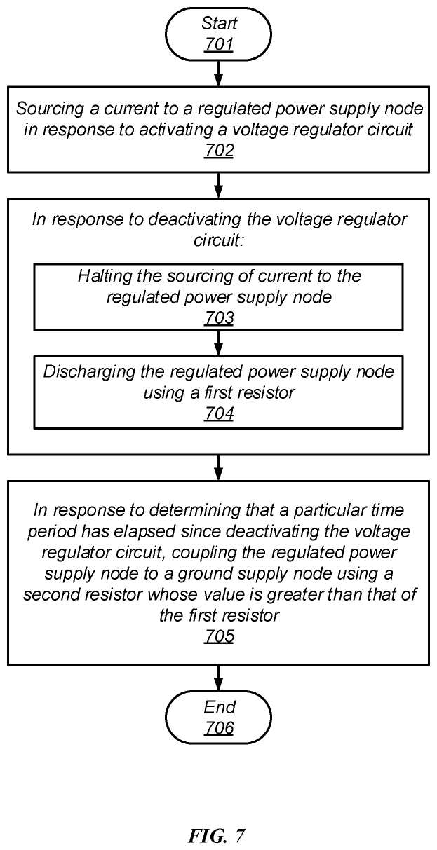

Turning to FIG. 7, a block diagram depicting an embodiment of a method for a power circuit is illustrated. The method, which may be applied to various power circuits, e.g., power circuit 100 as depicted in FIG. 1, begins in block 701.

The method includes sourcing a current to a regulated power supply node in response to activating a voltage regulator circuit (block 702). In various embodiments, sourcing the current to the regulated power supply node may include performing a comparison of a voltage level of the regulated power supply node to a reference voltage, and adjusting a conductance between input power supply node and the regulated power supply node using a result of the comparison.

The method further includes, in response to deactivating the voltage regulator circuit, halting the sourcing of current to the regulated power supply node (block 703). In various embodiments, the voltage regulator circuit includes a transistor coupled between the input power supply node and the regulated power supply node, and halting the sourcing of current to the regulated power supply node may include deactivating the transistor.

The method also includes, in response to deactivating the voltage regulator circuit, discharging the regulated power supply node using a first resistor (block 704). In some embodiments, discharging the regulated power supply node includes coupling the first resistor between the regulated power supply node and a ground supply node.

The method further includes, in response to determining that a particular time period has elapsed since deactivating the voltage regulator circuit, coupling the regulated power supply node to the ground supply node using a second resistor whose value is greater than that of the first resistor (block 705).

In some embodiments, the method may also include, in response to deactivating the voltage regulator circuit, incrementing a count value at periodic intervals, and activating an enable signal in response to determining that the count value exceeds a threshold value. The method may further include, in response to activating the enable signal, decoupling the first resistor from the regulated power supply node, and coupling the second resistor between the regulated power supply node and the ground supply node.

The method may also include adjusting a value of the second resistor using a plurality of control signals. In some embodiments, adjusting the value of the second resistor may include decoding the plurality of control signals to generate a plurality of decoded signals, and activating at least one of a plurality of transistors coupled to the regulated power supply node in response to activating a corresponding one of the plurality of decoded signals. In various embodiments, the method may further include adjusting the value of the second resistor based on temperature. The method concludes in block 706.

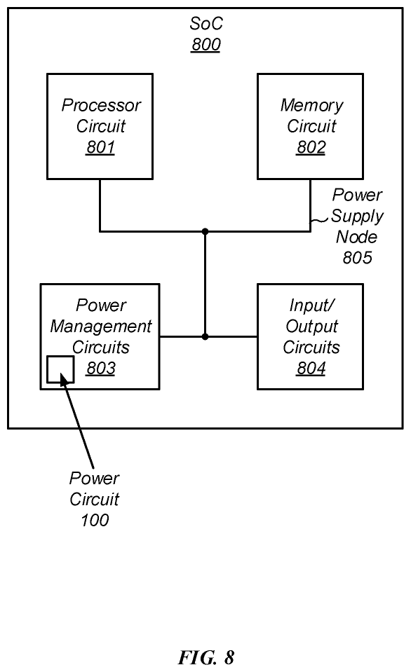

A block diagram of a system-on-a-chip (SoC) is depicted in FIG. 8. In the illustrated embodiment, SoC 800 includes processor circuit 801, memory circuit 802, power management circuits 803, and input/output circuits 804. In various embodiments, SoC 800 may be configured for use in a desktop computer, server, or in a mobile computing application such as a tablet, laptop computer, or wearable computing device.

Processor circuit 801 may, in various embodiments, be representative of a general-purpose processor that performs various operations in response to executing program or software instructions. For example, processor circuit 801 may be a central processing unit (CPU) such as a microprocessor, a microcontroller, an application-specific integrated circuit (ASIC), or a field-programmable gate array (FPGA).

Memory circuit 802 may, in various embodiments, include any suitable type of memory such as a dynamic random-access memory (DRAM) circuit, a static random-access memory (SRAM) circuit, a read-only memory (ROM) circuit, an electrically erasable programmable read-only memory (EEPROM) circuit, or a non-volatile memory circuit, for example. It is noted that, although a single memory circuit is illustrated in FIG. 8, in other embodiments, any suitable number of memory circuits may be employed.

Power management circuits 803 may include various power converter and voltage regulator circuits that may be configured to generate a regulated voltage level on power supply node 805. As depicted power management circuits 803 includes power circuit 100 as depicted in FIG. 1.

Input/output circuits 804 may be configured to coordinate data transfer between SoC 800 and one or more peripheral devices. Such peripheral devices may include, without limitation, storage devices (e.g., magnetic or optical media-based storage devices including hard drives, tape drives, CD drives, DVD drives, etc.), audio processing subsystems, or any other suitable type of peripheral devices. In some embodiments, input/output circuits 804 may be configured to implement a version of Universal Serial Bus (USB) protocol or IEEE 1394 (Firewire®) protocol.

Input/output circuits 804 may also be configured to coordinate data transfer between SoC 800 and one or more devices (e.g., other computing systems or integrated circuits) coupled to SoC 800 via a network. In one embodiment, input/output circuits 804 may be configured to perform the data processing necessary to implement an Ethernet (IEEE 802.3) networking standard such as Gigabit Ethernet or 10-Gigabit Ethernet, for example, although it is contemplated that any suitable networking standard may be implemented. In some embodiments, input/output circuits 804 may be configured to implement multiple discrete network interface ports.

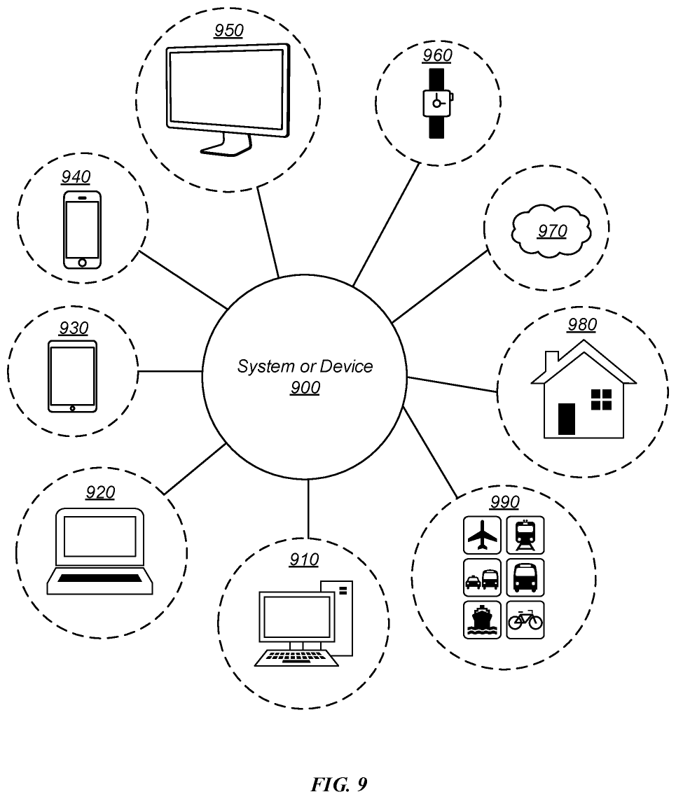

Turning to FIG. 9, various types of systems that may include any of the circuits, devices, or systems discussed above are illustrated. System or device 900, which may incorporate or otherwise utilize one or more of the techniques described herein, may be utilized in a wide range of areas. For example, system or device 900 may be utilized as part of the hardware of systems such as a desktop computer 910, laptop computer 920, tablet computer 930, cellular or mobile phone 940, or television 950 (or set-top box coupled to a television).

Similarly, disclosed elements may be utilized in a wearable device 960, such as a smartwatch or a health-monitoring device. Smartwatches, in many embodiments, may implement a variety of different functions. For example, smartwatches may provide access to e-mail, cellular service, calendar, health monitoring, etc. A wearable device may also be designed solely to perform health-monitoring functions, such as monitoring a user's vital signs, performing epidemiologic functions such as contact tracing, providing communication to an emergency medical service, etc. Other types of devices are also contemplated, including devices worn on the neck, implantable in the human body, glasses or a helmet designed to provide computer-generated reality experiences such as those based on augmented and/or virtual reality, etc.

System or device 900 may also be used in various other contexts. For example, system or device 900 maybe utilized in the context of a server computer system, such as a dedicated server or on shared hardware that implements a cloud-based service 970. Still further, system or device 900 may be implemented in a wide range of specialized everyday devices, including devices 980 commonly found in the home such as refrigerators, thermostats, security cameras, etc. The interconnection of such devices is often referred to as the “Internet of Things” (IoT). Elements may also be implemented in various modes of transportation. For example, system or device 900 could be employed in control systems, guidance systems, entertainment systems, etc. of various types of vehicles 990.

The applications illustrated in FIG. 9 are merely examples and not intended to limit the potential future applications of disclosed systems or devices. Other example applications include, without limitation: portable gaming devices, music players, data storage devices, unmanned aerial vehicles, etc.

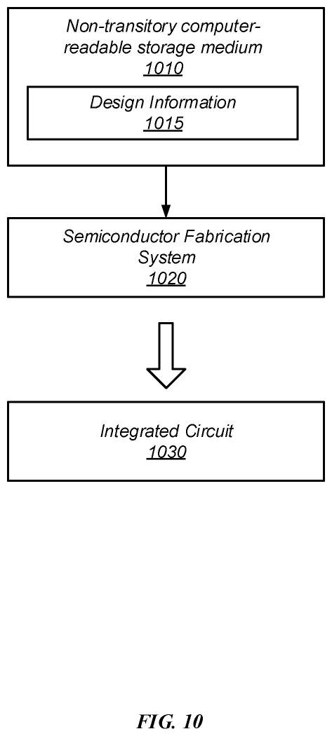

FIG. 10 is a block diagram depicting an example of a non-transitory computer-readable storage medium that stores circuit design information. In various embodiments, semiconductor fabrication system 1020 is configured to process design information 1015 stored on non-transitory computer-readable storage medium 1010 and fabricate integrated circuit 1030 based on design information 1015.

Non-transitory computer-readable storage medium 1010 may include various appropriate types of memory devices or storage devices. Non-transitory computer-readable storage medium 1010 may be an installation medium, e.g., a CD-ROM, floppy disks, or a tape device. Alternatively, non-transitory computer-readable storage medium 1010 may be a computer system memory or random-access memory such as dynamic random-access memory (DRAM), double data-rate random-access memory (DDR RAM), static random-access memory (SRAM), extended data out random-access memory (EDO RAM), Rambus RAM, etc. In some cases, non-transistory computer-readable storage medium 1010 may include non-volatile memory such as flash memory, magnetic media, e.g., a hard drive, or optical storage, registers, or other similar types of memory elements, etc. Non-transitory computer-readable storage medium 1010 may include two or more memory mediums, which may reside in different locations, e.g., in different computer systems that are connected over a network.

Design information 1015 may be specified using any of various appropriate computer languages, including hardware description languages such as, without limitation: VHDL, Verilog, SystemC, System Verilog, RHDL, M, MyHDL, and the like. Design information 1015 may be usable by semiconductor manufacturing system 1020 to fabricate at least a portion of integrated circuit 1030. The format of design information 1015 may be recognized by at least one semiconductor fabrication system, such as semiconductor fabrication system 1020, for example. In some embodiments, design information 1015 may include a netlist that specifies elements of a cell library, as well as their connectivity. One or more cell libraries used during logic synthesis of circuits included in integrated circuit 1030 may also be included in design information 1015. Such cell libraries may include information indicative of device or transistor level netlists, mask design data, characterization data, and the like, of the cells included in the cell library.

Integrated circuit 1030 may, in various embodiments, include one or more custom macrocells, such as a memory circuit, analog circuit, or mixed-signal circuits, and the like. In such cases, design information 1015 may include information related to such included macrocells. Such information may include, without limitation, schematics capture database information, mask design data, behavioral models, and device or transistor level netlists. As used herein, mask design data may be formatted according to graphic data system (GDSII), or any other suitable format.

Semiconductor fabrication system 1020 may include any of various appropriate elements configured to fabricate integrated circuits. This may include, for example, elements for depositing semiconductor materials (e.g., on a wafer which may include masking), removing materials, altering the shape of deposited materials, modifying materials (e.g., by doping materials or modifying dielectric constants using ultraviolet processing), etc., Semiconductor fabrication system 1020 may also be configured to perform various testing of fabricated circuits for correct operation.

In various embodiments, integrated circuit 1030 is configured to operate according to a circuit design specified by design information 1015, which may include performing any of the functionality described herein. For example, integrated circuit 1030 may include any of various elements show or described herein. Further integrated circuit 1030 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
a voltage regulator circuit configured to generate a particular voltage level on a regulated power supply node; and
a pull-down circuit configured, in response to a deactivation of the voltage regulator circuit, to:
couple a first resistor between the regulated power supply node and a ground supply node for a particular time period; and
in response to a determination that the particular time period has elapsed:
decouple the first resistor from the regulated power supply node; and
couple a second resistor between the regulated power supply node and the ground supply node, wherein a first value of the first resistor is less than a second value of the second resistor.

2. The apparatus of claim 1, wherein the pull-down circuit is further configured to adjust, using a plurality of control signals, the first value of the first resistor and the second value of the second resistor.

3. The apparatus of claim 2, wherein the pull-down circuit includes:
a decoder circuit configured to decode the plurality of control signals to generate a plurality of decoded signals; and
a plurality of transistors coupled to the regulated power supply node, including a particular transistor configured to couple the regulated power supply node to the ground supply node in response to an activation of a corresponding one of the plurality of decoded signals.

4. The apparatus of claim 2, wherein the pull-down circuit includes:
a counter circuit configured, in response to the deactivation of the voltage regulator circuit, to initiate a periodic incrementing of a count value; and
a control circuit configured to activate an enable signal in response to a determination that the count value exceeds a threshold value; and
wherein the pull-down circuit is further configured, in response to an activation of the enable signal, to:
decouple the first resistor from between the regulated power supply node and the ground supply node; and
couple the second resistor between the regulated power supply node and the ground supply node.

5. The apparatus of claim 4, wherein the control circuit is further configured to activate particular ones of the plurality of control signals based on temperature.

6. The apparatus of claim 1, wherein the voltage regulator circuit includes:
a control circuit configured to:
perform a comparison of a reference voltage to a voltage level of the regulated power supply node; and
generate a control signal based on a result of the comparison; and
a transistor coupled between an input power supply node and the regulated power supply node, wherein the transistor is configured to adjust a conductance between the input power supply node and the regulated power supply node using the control signal.

7. A method, comprising:
sourcing a current to a regulated power supply node in response to activating a voltage regulator circuit;
in response to deactivating the voltage regulator circuit:
halting the sourcing of current to the regulated power supply node; and
discharging the regulated power supply node to ground using a first resistor; and
in response to determining that a particular period of time has elapsed since deactivating the voltage regulator circuit, coupling the regulated power supply node to a ground supply node using a second resistor whose value is greater than that of the first resistor.

8. The method of claim 7, further comprising, using a plurality of control signals, adjusting a value of the second resistor.

9. The method of claim 8, further comprising:
decoding the plurality of control signals to generate a plurality of decoded signals; and
activating at least one of a plurality of transistors coupled to the regulated power supply node in response to activating a corresponding one of the plurality of decoded signals.

10. The method of claim 7, further comprising:
in response to deactivating the voltage regulator circuit, incrementing a count value at periodic intervals; and
activating an enable signal in response to determining that the count value exceeds a threshold value.

11. The method of claim 10, further comprising, in response to activating the enable signal:
decoupling the first resistor from the regulated power supply node; and
coupling the second resistor between the regulated power supply node and the ground supply node.

12. The method of claim 7, further comprising adjusting a value of the second resistor based on temperature.

13. The method of claim 7, wherein sourcing the current to the regulated power supply node includes:
performing a comparison between a voltage level of the regulated power supply node to a reference voltage; and
adjust a conductance between an input power supply node and the regulated power supply node using a result of the comparison.

14. A system, comprising:
a load circuit coupled to a regulated power supply node; and
a power circuit configured to:
source a current to the regulated power supply node in response to an activation of a power control signal;
in response to a deactivation of the power control signal:
halt sourcing the current to the regulated power supply node; and
discharge the regulated power supply node to ground using a first resistor; and
in response to a determination that a particular period of time has elapsed since the power control signal was deactivated, couple the regulated power supply node to a ground supply node using a second resistor whose value is greater than that of the first resistor.

15. The system of claim 14, wherein the power circuit is further configured to adjust a value of the second resistor using a plurality of control signals.

16. The system of claim 15, wherein to adjust the value of the second resistor, the power circuit is further configured to:
decode the plurality of control signals to generate a plurality of decoded signals; and
activate at least one of a plurality of transistors coupled to the regulated power supply node in response to an activation of a corresponding one of the plurality of decoded signals.

17. The system of claim 14, wherein the power circuit is further configured to:
in response to the deactivation of the power control signal, increment a count value at periodic intervals; and
activate an enable signal in response to a determination that the count value exceeds a threshold value.

18. The system of claim 17, wherein the power circuit is further configured, in response to an activation of the enable signal, to:
decouple the first resistor from the regulated power supply node; and
couple the second resistor between the regulated power supply node and the ground supply node.

19. The system of claim 14, wherein the power circuit is further configured to adjust a value of the second resistor based on temperature.

20. The system of claim 14, wherein to source the current to the regulated power supply node, the power circuit is further configured to:
perform a comparison between a voltage level of the regulated power supply node to a reference voltage; and
adjust a conductance between an input power supply node and the regulated power supply node using a result of the comparison.
